(19) United States
(12) Patent Application Publication
(10) Pub. No.: US 2025/0196704 A1
(43) Pub. Date: Jun. 19, 2025

(54) BATTERY REPLACEMENT SYSTEM AND BATTERY

(71) Applicant: TOYOTA JIDOSHA KABUSHIKI KAISHA, Toyota-shi (JP)

(72) Inventor: Shinji ICHIKAWA, Nagoya-shi (JP)

(73) Assignee: TOYOTA JIDOSHA KABUSHIKI KAISHA, Toyota-shi (JP)

(21) Appl. No.: 18/958,109

(22) Filed: Nov. 25, 2024

(30) Foreign Application Priority Data
Dec. 18, 2023 (JP) 2023-213087

(51) Int. Cl. B60L 53/80; B60L 50/64; B60L 58/12

(52) U.S. Cl. CPC B60L 53/80; B60L 50/64; B60L 58/12; B60L 2240/547; B60L 2240/549; B60L 2240/70

(57) ABSTRACT

The battery replacement system includes an electrified vehicle capable of replacing a battery, a battery mounted on electrified vehicle, and a control device. The control device stores vehicle characteristic information indicating a characteristic of electrified vehicle when electrified vehicle is driven, in association with the battery identification information of the battery, the battery characteristic information indicating the characteristic of the battery, and the vehicle identification information of electrified vehicle. When the battery is mounted on electrified vehicle, the control device generates battery information based on the battery characteristic information and the vehicle characteristic information corresponding to the vehicle identification information, and transmits the battery information to electrified vehicle.

### CROSS-REFERENCE TO RELATED APPLICATION

This application claims priority to Japanese Patent Application No. 2023-213087 filed on Dec. 18, 2023, incorporated herein by reference in its entirety.

### BACKGROUND

### 1. Technical Field

The present disclosure relates to a battery and a battery replacement system.

### 2. Description of Related Art

Japanese Unexamined Patent Application Publication No. 2023-101504 (JP 2023-101504 A) discloses a vehicle equipped with a replaceable battery.

### SUMMARY

Although not clearly described in JP 2023-101504 A, there is a case where the battery is not limited to a particular type of electrified vehicle when replaced. For this reason, the battery may be mounted on an electrified vehicle that performs vehicle control inappropriate to the battery. In this case, the battery performance of the battery may rapidly decrease.

The present disclosure has been made to solve the above problem, and an object thereof is to provide a battery replacement system and a battery in which damage to the battery due to vehicle control of an electrified vehicle where the battery is mounted by battery replacement is suppressed.

A battery replacement system according to a first aspect of the present disclosure includes: an electrified vehicle configured to perform battery replacement; a battery to be mounted on the electrified vehicle; and a control device. The control device is configured to store vehicle characteristic information indicating a characteristic of the electrified vehicle at a time of driving the electrified vehicle in association with battery identification information of the battery, battery characteristic information indicating a characteristic of the battery, and vehicle identification information of the electrified vehicle. The control device is configured to generate battery information based on the battery characteristic information and the vehicle characteristic information associated with the vehicle identification information when the battery is mounted on the electrified vehicle, and transmit the battery information to the electrified vehicle.

In the control device according to the first aspect of the present disclosure, as described above, when the battery is mounted on the vehicle, the control device acquires the vehicle characteristic information associated with the vehicle specific information of the vehicle after the mounting. The battery information is generated based on the battery characteristic information of the battery and the acquired vehicle characteristic information, and the battery information is transmitted to the electrified vehicle. In this way, the battery transmits the battery information generated based on the vehicle characteristic information to the electrified vehicle. Since the electrified vehicle performs vehicle control based on the battery information acquired from the battery, it is possible to suppress damage to the battery due to the vehicle control of the electrified vehicle.

The battery replacement system according to the first aspect of the present disclosure further includes a battery replacement station where the battery is stored. The battery may be configured to notify a user of the electrified vehicle about the battery information when the battery information is transmitted to the electrified vehicle.

With this configuration, the user can recognize the battery information of the battery mounted on the electrified vehicle.

In the battery replacement system according to the first aspect of the present disclosure, the battery may be configured to notify the user about the battery information by transmitting the battery information to at least one of a display device mounted on the electrified vehicle and a user terminal owned by the user.

With this configuration, the user can visually recognize the battery information. Therefore, the battery information of the battery mounted on the electrified vehicle can be easily transmitted to the user.

In the battery replacement system according to the first aspect of the present disclosure, the battery may be configured to, when the vehicle characteristic information associated with the electrified vehicle where the battery is mounted is stored in the control device, determine whether the battery information changed from the battery characteristic information needs to be generated based on the battery characteristic information and the vehicle characteristic information associated with the electrified vehicle. When a determination is made that the battery information changed from the battery characteristic information needs to be generated, the battery may be configured to generate the battery information based on the battery characteristic information and the vehicle characteristic information, and transmit the generated battery information. When a determination is made that the battery information changed from the battery characteristic information does not need to be generated, the battery may be configured to transmit the battery characteristic information as the battery information. The battery may be configured to, when the vehicle characteristic information associated with the electrified vehicle where the battery is mounted is not stored in the control device, transmit the battery characteristic information as the battery information.

With this configuration, the battery information changed from the battery characteristic information can be generated only when a determination is made that the battery information changed from the battery characteristic information needs to be generated based on the vehicle characteristic information stored in the control device.

A battery according to a second aspect of the present disclosure is a battery to be mounted on an electrified vehicle configured to perform battery replacement. The battery includes: a control device; and a communication unit configured to communicate with the electrified vehicle. The control device is configured to generate battery information based on vehicle characteristic information indicating a characteristic of the electrified vehicle at a time of driving the electrified vehicle. The communication unit is configured to transmit the battery information to the electrified vehicle.

With this configuration, the battery transmits the battery information generated based on the vehicle characteristic information to the electrified vehicle. Since the electrified vehicle performs vehicle control based on the battery information acquired from the battery, it is possible to suppress harmful use of the battery due to the vehicle control of the electrified vehicle.

According to the present disclosure, it is possible to reduce such a situation that the battery mounted on the electrified vehicle by battery replacement is damaged due to the vehicle control of the electrified vehicle that deviates from the specifications of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a battery replacement system according to the present embodiment;

FIG. 2 is a diagram illustrating a table recorded in the server according to the present embodiment;

FIG. 3 is a diagram illustrating a sequence of control between a server and a battery according to the present embodiment;

FIG. 4 is a diagram showing a sequence for changing the battery characteristic information according to the present embodiment; and

FIG. 5 is a diagram illustrating a sequence for changing battery characteristic information according to the present embodiment.

### DETAILED DESCRIPTION OF EMBODIMENTS

Hereinafter, an embodiment of the present disclosure will be described in detail with reference to the drawings. The same or corresponding parts in the drawings are designated by the same reference signs and repetitive description will be omitted.

### Configuration of Battery Replacement System

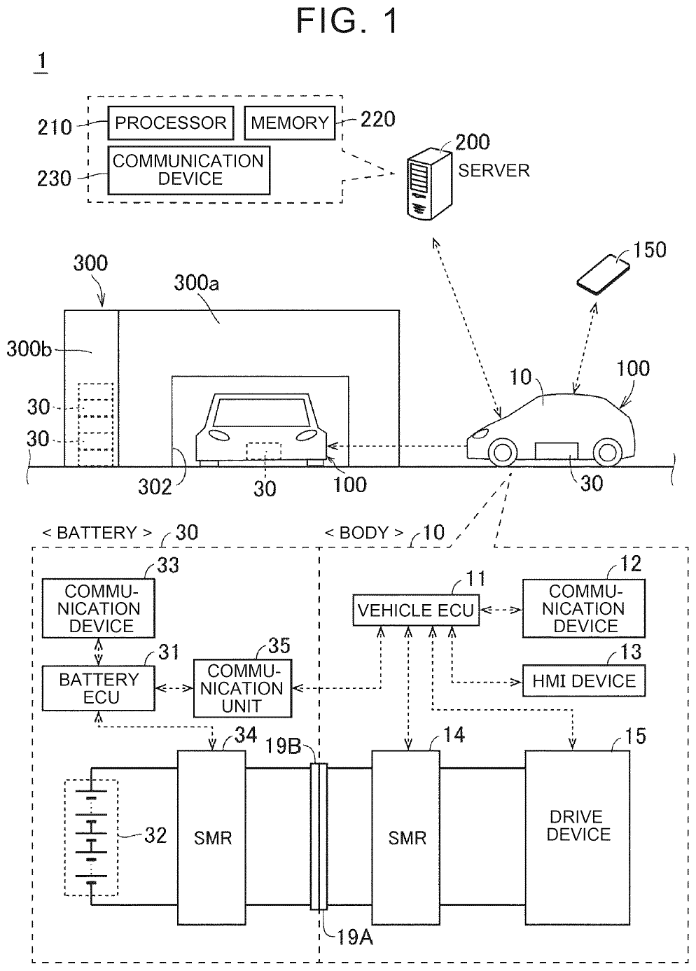

FIG. 1 is a diagram illustrating a battery replacement system.

The battery replacement system 1 includes an electrified vehicle 100, server 200, and a battery replacement device 300. Electrified vehicle 100 is, for example, PHEV (Plug-in Hybrid Electric Vehicle), BEV (Battery Electric Vehicle), or FCEV (Fuel Cell Electric Vehicle). Note that the server 200 is an example of a “control device” of the present disclosure.

Electrified vehicle 100 includes a vehicle body 10 and a battery 30. The vehicle body 10 is a part of electrified vehicle 100 other than the battery 30. Vehicle ECU (Electronic Control Unit) 11, a communication device 12, an HMI device 13, a SMR 14, a drive device 15, and a terminal 19A. Note that HMI device 13 is an exemplary “display device” of the present disclosure.

The vehicle ECU 11 records information on an electrified vehicle (hereinafter, referred to as “vehicle identification information”) to be described later. The vehicle ECU 11 is configured to communicate with each of the communication device 12, HMI device 13, SMR 14, the drive device 15, and the battery ECU 31 via a communication unit 35, which will be described later, by, for example, CAN (Controller Area Network) communication. The vehicle ECU 11 controls the drive device 15 based on the battery data acquired from the battery 30.

Note that the battery information includes, for example, at least part of information indicating the upper limit input power (Winmax), the upper limit output power (Woutmax), the allowable current value, the allowable voltage value, the upper limit output current, the upper limit input current, the upper limit voltage, the lower limit voltage, the lower limit SOC, the upper limit battery temperature, and the lower limit battery temperature of the battery 30.

The communication device 12 is configured to be able to communicate with the server 200 and the battery replacement device 300. Note that the communication device 12 may be capable of communicating with the user terminal 150 such as a mobile telephone possessed by the user of electrified vehicle.

HMI device 13 is mounted on a vehicle, and displays various kinds of information (for example, map information and video content) on a display screen, and notifies various kinds of information (for example, traffic information, weather information, and the like) by sound. HMI device 13 includes a display including a touch panel, a speaker, and the like.

SMR 14 is provided between the drive device 15 and the battery 30. SMR 14 is formed so as to be able to switch the electrical connection between the drive device 15 and the battery 30 in accordance with an instruction from the vehicle ECU 11. Note that “SMR” means a system main relay (System Main Relay).

The drive device 15 includes a MG (Motor Generator (not shown)) and a PCU (Power Control Unit). The drive device 15 is formed so as to be able to drive electrified vehicle 100 by using the electric power outputted from the battery 30.

MG functions as a driving motor. MG is electrically connected to the battery 30 via a PCU. MG converts the power from the battery 30 into torques and rotates the drive wheels of electrified vehicle 100. Further, MG performs regenerative power generation, for example, at the time of deceleration of electrified vehicle 100, and charges the battery 30.

PCU includes inverters and converters. PCU supplies power supplied from the battery 30 to MG under the control of the vehicle ECU 11.

The terminal 19A is formed to be electrically connectable to a terminal 19B formed in the battery 101. The vehicle body 10 is formed to be electrically connectable to the battery 101 via a terminal 19A, 19B.

The battery 30 includes a battery ECU 31, a power storage module 32, a communication device 33, a SMR 34, and a terminal 19B. The battery 30 is formed to be replaceable in the battery replacement device 300. Note that the battery ECU 31 is an exemplary “control device” of the present disclosure.

The battery ECU 31 records information on a battery 30 (hereinafter, referred to as “battery specific information”) described later. The battery ECU 31 is formed so as to be able to communicate with each of the vehicle ECU 11 and SMR 22 by, for example, CAN communication via a communication unit 35 which will be described later. The battery ECU 31 is formed so as to be capable of switching SMR 22 based on an instruction from the vehicle ECU 11.

The power storage module 32 is, for example, a secondary battery such as a lithium ion battery, a nickel metal hydride battery, or a sodium ion battery. The type of the secondary battery may be a liquid secondary battery or an all-solid secondary battery. The power storage module 32 is formed to be electrically connectable to the vehicle body 10 by connecting the terminal 19A and the terminal 19B.

The communication device 33 is configured to be able to communicate with the server 200 and the battery replacement device 300. SMR 34 is provided between the power storage module 32 and the terminal 19B. SMR 34 is formed so as to be capable of switching the electric connectivity between the power storage module 32 and the terminal 19B in accordance with an instruction from the battery ECU 31. The communication unit 35 is formed so that the battery ECU 31 can communicate with the vehicle ECU 11.

The server 200 includes a processor 210, a memory 220, and a communication device 230. The memory 220 stores a program to be executed by the processor 210 and information (for example, a map, a mathematical expression, and various parameters) used in the program. The communication device 230 is configured to be able to communicate with the communication device 33.

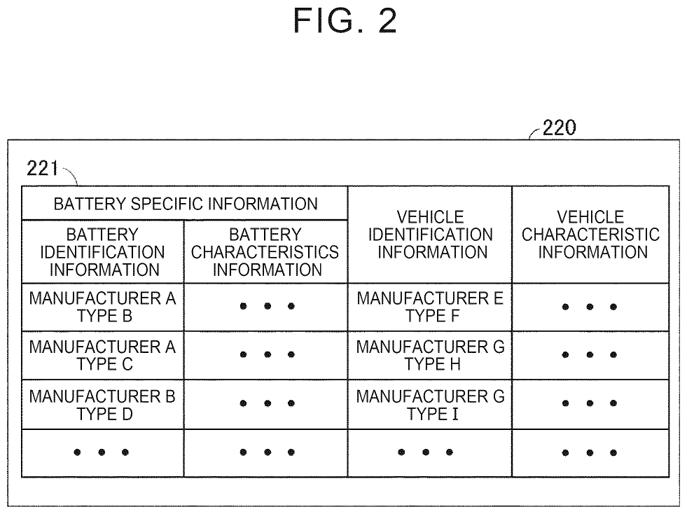

The memory 220 stores a table 221 illustrated in FIG. 2. In the table 221, battery specific information (including battery identification information and battery characteristic information), vehicle identification information, and vehicle characteristic information are recorded in association with each other.

The battery identification information constituting a part of the battery specific information includes information of the battery manufacturer related to the battery 30 and information of the type of the battery.

The battery characteristic information constituting a part of the battery specific information includes information indicating an upper limit input power (Winmax) above the specification of the battery 30, an upper limit output power (Woutmax), an allowable current value, an allowable voltage value, an upper limit output current, an upper limit input current, an upper and lower limit voltage, a lower limit SOC, and an upper and lower limit battery temperature. The vehicle-identification information includes at least a part of the information of the manufacturer of electrified vehicle 100 and the information of the type.

The vehicle characteristic information includes vehicle characteristic information at the time of driving electrified vehicle 100 (at the time of traveling, charging, and the like). More specifically, the vehicle characteristic information includes one of the information indicating the relationship between the temperature of PCU and the input power and the output power of the battery 30 when the vehicle is traveling, the input power according to the battery 30 when the vehicle is traveling, the output power, voltage, current, information indicating the battery remaining amount and battery temperature, the charging power according to the battery 30 at the time of charging, charging voltage, charging current and battery temperature, and the like information. At least, the vehicle characteristic information includes information indicating a relation between the temperature of PCU and the input/output power of the battery 30 when the vehicle is traveling.

The information of the table 221 is created based on the vehicle-characteristic information of electrified vehicle 100 when each of the plurality of electrified vehicle including electrified vehicle 100 is driven (traveling, charging, and the like). For example, it is assumed that electrified vehicle 100 is a type F vehicle of the manufacturer E and is equipped with a type B battery 30 of the manufacturer A. In this case, the vehicle-characteristic information of electrified vehicle 100 at the time of driving is transmitted from the battery 30 to the server 200. Then, the information of the table 221 (the vehicle characteristic information corresponding to the type B battery-specific information of the manufacturer A and the type F vehicle identification information of the manufacturer E) stored in the memory 220 of the server 200 is updated based on the information from the battery 30. In a case where the vehicle characteristic information corresponding to the type B battery specific information of the manufacturer A and the type F vehicle identification information of the manufacturer E are not stored in the memory 220, the information from the battery 30 is newly registered in the memory 220.

Referring back to FIG. 1, the battery replacement device 300 includes a battery replacement device main body 300a in which battery replacement is performed, and a storage 300b in which the battery 30 is stored. Various types of batteries 30 may be stored in the storage 300b. The battery replacement device main body 300a is an apparatus that performs battery replacement for replacing the battery 30 mounted on electrified vehicle 100 with the battery 30 stored in the storage. The storage 300b is installed in the battery replacement device main body 300a. The battery replacement device 300 (battery replacement device main body 300a) is provided with an entrance 302 for electrified vehicle 100 to and from.

Here, as the vehicle for replacing the battery in the battery replacement device 300, there are various vehicles such as a new vehicle, a used vehicle, a SUV type, and a sporting type. For this reason, in some vehicles, for example, there are vehicles in which PCU becomes high in temperature during traveling, or charges exceeding the upper limit charging power of the battery during charging. As a result, the vehicle itself may be damaged or the battery may be damaged.

On the other hand, in the present embodiment, after the battery is replaced, the battery ECU 31 acquires the vehicle characteristic information corresponding to the vehicle identification information of electrified vehicle 100 on which the battery 30 is mounted from the server 200 (the memory 220) through the communication device 33.

Then, the battery ECU 31 generates battery information to be transmitted to electrified vehicle 100 by using the battery characteristic information and the vehicle characteristic information acquired from the server 200.

For example, for an electrified vehicle 100 in which the temperature of PCU is not increased during traveling, the battery 30 sets the upper limit output power of the battery information to be transmitted to electrified vehicle to be lower than the upper limit output power of the battery property information and transmits the battery information to electrified vehicle 100. Electrified vehicle 100 sets, for example, the power to be supplied to PCU based on the upper limit power of the received battery data. As a consequence, the current flowing through PCU can be suppressed to be small during the traveling, and the heat generation of PCU can be suppressed. As a result, it is possible to restrain electrified vehicle 100 from being damaged.

Further, for example, the battery ECU 31 determines that the battery 30 is mounted on a electrified vehicle 100 that performs vehicle control such that the allowable current of the battery is exceeded at the time of driving, or determines that the battery is mounted on a electrified vehicle 100 that deviates from the allowable range of the battery temperature at the time of driving, for example, transmits battery information in which the allowable current value is set lower than the battery characteristic information to the vehicle ECU 11. Since electrified vehicle 100 performs vehicle control based on the acquired battery data, it is possible to restrain the vehicle control from exceeding the allowable current of the battery or from deviating from the allowable battery temperature when the vehicle is driven. Control method for changing battery information.

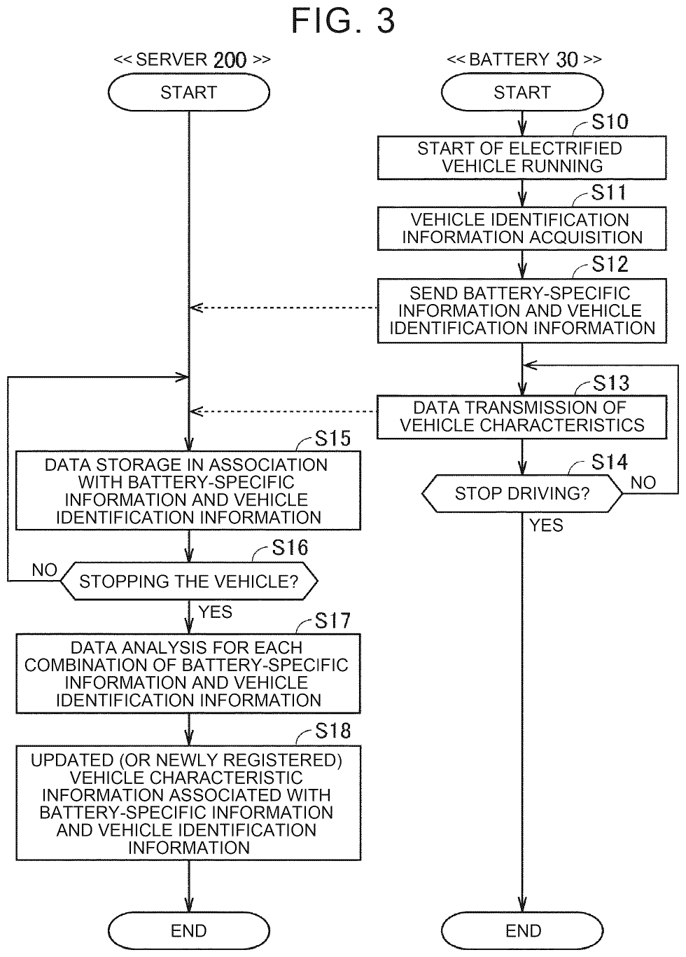

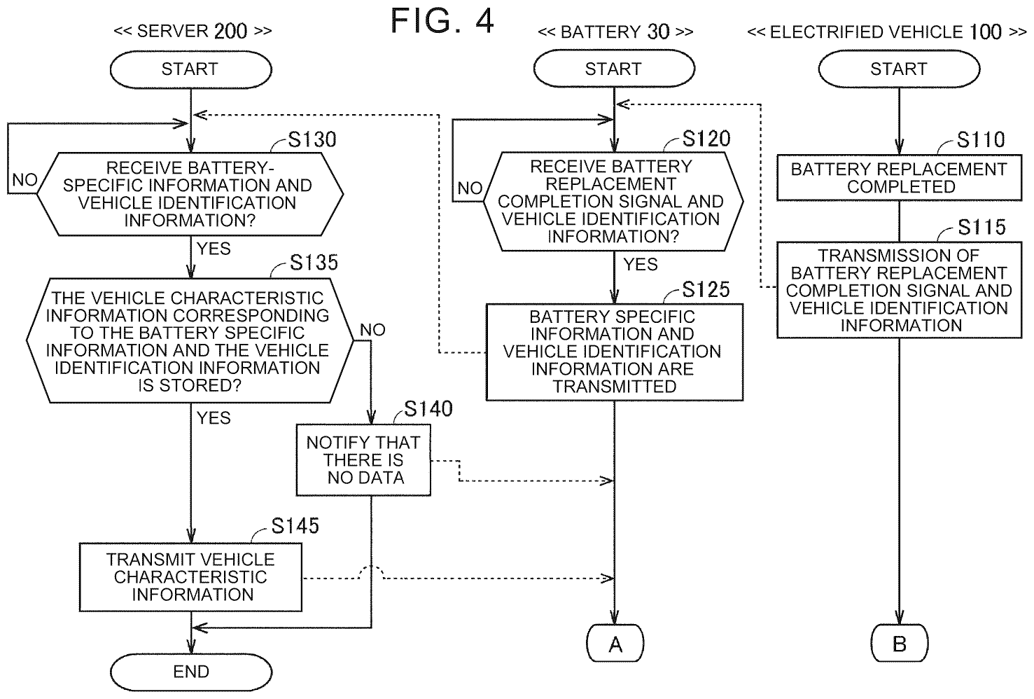

Next, a control method for generating battery information of the battery 30 will be described with reference to FIGS. 3 and 4.

FIG. 3 shows a sequence when the information of the server 200 is updated based on the vehicle-characteristic information when electrified vehicle 100 is driven. First, it is assumed that traveling of electrified vehicle 100 is started in S10.

In S11, the battery ECU 31 obtains the vehicle identity from the vehicle ECU 11.

In S12, the battery ECU 31 transmits the battery-specific information and the vehicle-identification information to the server 200 through the communication device 33.

In S13, the battery ECU 31 transmits data of the vehicle characteristics of electrified vehicle 100 during the traveling of electrified vehicle 100 (actual measurement data such as the output power, the voltage, the current, the battery remaining amount, and the temperature of the battery 30) to the server 200 through the communication device 33.

In S14, the battery ECU 31 determines whether electrified vehicle 100 has stopped running. When the running of electrified vehicle 100 is stopped (Yes in S14), the process of the battery 30 is ended. If electrified vehicle 100 has not stopped running (No in S14), the process returns to S13.

In S15, the server 200 accumulates (stores) the vehicle characteristic data in association with the battery specific information of the battery 30 and electrified vehicle 100 vehicle identification information. The data is stored in the memory 220.

In S16, the server 200 determine whether or not electrified vehicle 100 has stopped running. For example, the server 200 may determine that electrified vehicle 100 has stopped based on a notification from the battery ECU 31. When it is determined that the traveling of electrified vehicle 100 is stopped, the process proceeds to S17. When it is determined that the traveling of electrified vehicle 100 is not stopped, the process returns to S15.

In S17, the server 200 perform data analysis on data of all past vehicle characteristics accumulated in association with the battery-specific information and the vehicle identification information. The data analysis result is synonymous with the vehicle characteristic information.

In S18, the server 200 update the battery characteristic information generated in S17 from the pre-existing battery characteristic information. Specifically, when there is battery characteristic information corresponding to the combination of the battery-specific information and the vehicle-identification information in the memory 220, the server 200 updates the existing battery characteristic information to the battery characteristic information based on the analysis result of S17. If there is no pre-existing battery characteristic information, the vehicle characteristic information based on S17 analysis result is newly registered in the memory 220.

FIG. 4 is a diagram illustrating a sequence for generating battery information of a battery based on vehicle characteristic information stored in a server. In S110, it is assumed that the battery 30 of electrified vehicle 100 is replaced in the battery replacement device 300.

In S115, the vehicle ECU 11 transmits a battery replacement completion signal and vehicle identity information to the battery ECU 31. Note that S115 is not necessarily started immediately after the completion of the replacement of batteries (S110). After the replacement of the batteries is completed, the batteries may be started as appropriate while electrified vehicle 100 is running.

In S120, the battery ECU 31 determines whether the battery replacement completion signal and the vehicle identification information have been received. If received (Yes in S120), the process proceeds to S125. If not, the process returns to S120 (No in S120).

In S125, the battery ECU 31 transmits the battery-specific information and the vehicle-identification information to the server 200 via the communication device 33.

In S130, the server 200 determine whether the battery-specific information and the vehicle-identification information have been received. If received (Yes in S130), the process proceeds to S135. If not, the process returns to S130 (No in S130).

In S135, the server 200 determines whether or not the vehicle characteristic information corresponding to the battery-specific information and the vehicle identification information is stored in the memory 220. If the vehicle-characteristic data is stored (Yes in S135), the process proceeds to S145. When the vehicle-characteristic data is not stored (No in S135), the process proceeds to S140.

In S140, the server 200 transmits, to the battery 30, a message indicating that the vehicle characteristic information corresponding to the battery specific information of the battery 30 and the vehicle identification information of electrified vehicle 100 on which the battery 30 is mounted is not stored in the memory 220. Note that the information indicating that there is no data may also be transmitted to the user terminal 150. Thereafter, the control of the server 200 ends.

In S145, the server 200 transmits the battery specific information of the battery 30 and the vehicle characteristic information corresponding to the vehicle identification information of electrified vehicle 100 on which the battery 30 is mounted to electrified vehicle 100. Thereafter, the control of the server 200 ends.

In S149, the battery ECU 31 determines whether a notification indicating that there is no data is received. If a notification is received (Yes in S149), the process proceeds to S160. If no notification has been received (No in S149), the process proceeds to S150.

In S150, the battery ECU 31 determines whether the vehicle-characteristic-information has been received. That is, the battery ECU 31 determines whether or not the battery 30 and electrified vehicle 100 on which the battery 30 is mounted have been combined. When the battery property data is received (Yes in S150), the process proceeds to S155. When the vehicle-characteristic data is not received (No in S150), the process returns to S149.

In S155, the battery ECU31 determines whether the battery characteristic information can be transmitted as the battery information based on the battery characteristic information and the vehicle characteristic information. For example, the battery ECU31 compares the battery characteristic information of the battery 30 with the vehicle characteristic information to make the above determination. If the battery property information can be transmitted as the battery information (Yes in S155), the process proceeds to S160. When the battery property information is not transmitted as the battery information (No in S155), the process proceeds to S165.

In S160, the battery ECU31 transmits battery property information as battery information. Thereafter, the control of the battery ECU31 ends.

In S165, the battery ECU31 generates battery information in which the value is changed from the battery characteristic information (maximum input and output of the battery 30, the upper and lower limit voltages, the upper limit current, the upper and lower limit SOC, or the like) based on the vehicle characteristic information. Specifically, the battery characteristic information is compared with the vehicle characteristic information, and when, for example, electrified vehicle 100 is driven to exceed the threshold value of the allowable current value, the battery ECU31 generates battery information in which a value obtained by reducing the allowable current value included in the battery characteristic information by an amount exceeding the threshold value is set as the allowable current value.

In S170, the battery ECU31 transmits the battery information obtained by changing the battery property information to the vehicle ECU11. Thereafter, the control of the battery ECU31 ends.

In S175, the vehicle ECU11 determines whether battery data has been received from the battery ECU31. The battery ECU31 that has received the battery information controls the vehicles based on the battery information. When the battery data is received (Yes in S175), the process proceeds to S180. If no batteries are received (No in S175), the process repeats S175.

In S180, the vehicle ECU11 may display the battery information received from the battery ECU31 on HMI device 13 and notify the user of electrified vehicle 100 of the battery information. The vehicle ECU11 may display the battery information received from the battery ECU31 on the user terminal 150. Further, the vehicle ECU11 may acquire battery property information from the battery ECU31 and display the battery property information together with the battery information. Thereafter, the control of the vehicle ECU11 ends.

As described above, in the present embodiment, after the battery replacement is completed, the vehicle characteristic information corresponding to the vehicle identification information of electrified vehicle 100 on which the battery 30 is mounted is acquired from the servers 200. The battery 30 generates battery information using the acquired vehicle characteristic information, and the battery 30 transmits the battery information to the vehicle ECU11. Electrified vehicle 100 controls the vehicle based on the battery-information. Accordingly, it is possible to restrain electrified vehicle 100 from deviating from the battery property data of the battery 30 and controlling the vehicle. Then, it is possible to restrain the battery 30 from being damaged due to the control of electrified vehicle 100.

In the present embodiment, the server 200 analyzes the vehicle characteristic data using the vehicle characteristic data newly accumulated after the vehicle is stopped, and updates the existing vehicle characteristic data, but the present disclosure is not limited to this.

The server 200 may analyze the vehicle characteristic data and update the existing vehicle characteristic information every time the predetermined vehicle characteristic data is accumulated even during the vehicle running.

In the present embodiment, the server 200 receives the vehicle characteristic data associated with the battery specific information and the vehicle identification information from the battery ECU31, analyzes the vehicle characteristic data, and newly creates or updates the analyzed data (vehicle characteristic information), but the present disclosure is not limited thereto.

The battery ECU31 may store vehicle characteristic data in association with the vehicle identification information, analyze the vehicle characteristic data, and newly create or update the analyzed data (vehicle characteristic information).

In the present embodiment, the battery ECU31 determines whether or not the battery characteristic information can be transmitted as the battery information based on the vehicle characteristic information, and when it is determined that there is the battery characteristic information, the battery ECU31 creates the battery information in which the value of the battery characteristic information is changed based on the vehicle characteristic information, but the present disclosure is not limited thereto.

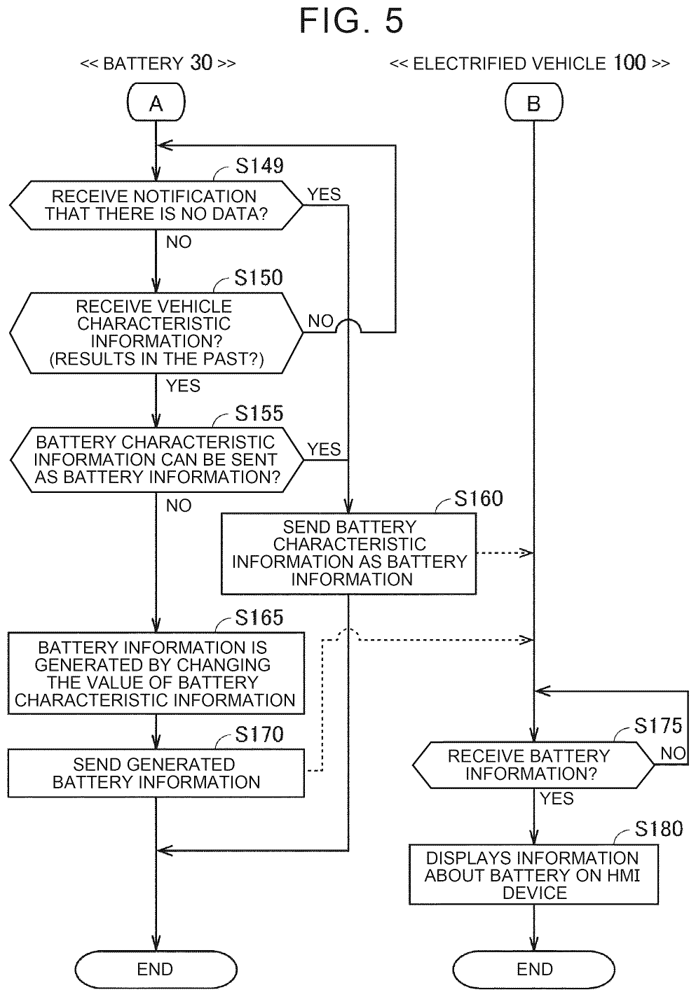

When the server 200 determines whether or not the battery characteristic information can be transmitted as the battery information based on the vehicle characteristic information and determines that the battery characteristic information is present, the server 200 may generate the battery information in which the value is changed from the battery characteristic information based on the vehicle characteristic information. When receiving the battery specific information and the vehicle identification information from the battery 30, the server 200 may transmit the battery information instead of the vehicle characteristic information in S145 of FIG. 4. In this case, the battery 30 may transmit the received battery information to the vehicle ECU11 without determining whether or not the battery property information can be transmitted as battery information (S155 of FIG. 5).

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A battery replacement system comprising:
an electrified vehicle configured to perform battery replacement;
a battery to be mounted on the electrified vehicle; and
a control device, wherein
the control device is configured to store vehicle characteristic information indicating a characteristic of the electrified vehicle at a time of driving the electrified vehicle in association with battery identification information of the battery, battery characteristic information indicating a characteristic of the battery, and vehicle identification information of the electrified vehicle, and
the control device is configured to generate battery information based on the battery characteristic information and the vehicle characteristic information associated with the vehicle identification information when the battery is mounted on the electrified vehicle, and transmit the battery information to the electrified vehicle.

2. The battery replacement system according to claim 1, wherein
the battery is configured to notify a user of the electrified vehicle about the battery information when the battery information is transmitted to the electrified vehicle.

3. The battery replacement system according to claim 2, wherein
the battery is configured to notify the user about the battery information by transmitting the battery information to at least one of a display device mounted on the electrified vehicle and a user terminal owned by the user.

4. The battery replacement system according to claim 1, wherein:
the battery is configured to, when the vehicle characteristic information associated with the electrified vehicle where the battery is mounted is stored in the control device,
determine whether the battery information changed from the battery characteristic information needs to be generated based on the battery characteristic information and the vehicle characteristic information associated with the electrified vehicle,
when a determination is made that the battery information changed from the battery characteristic information needs to be generated, generate the battery information based on the battery characteristic information and the vehicle characteristic information, and transmit the generated battery information, and
when a determination is made that the battery information changed from the battery characteristic information does not need to be generated, transmit the battery characteristic information as the battery information; and
the battery is configured to, when the vehicle characteristic information associated with the electrified vehicle where the battery is mounted is not stored in the control device,
transmit the battery characteristic information as the battery information.

5. A battery to be mounted on an electrified vehicle configured to perform battery replacement, the battery comprising:
a control device; and
a communication unit configured to communicate with the electrified vehicle, wherein
the control device is configured to generate battery information based on vehicle characteristic information indicating a characteristic of the electrified vehicle at a time of driving the electrified vehicle, and
the communication unit is configured to transmit the battery information to the electrified vehicle.
